(19) United States
(12) Patent Application Publication
(10) Pub. No.: US 2005/0138077 A1
(43) Pub. Date: Jun. 23, 2005

(54) Context sensitive streaming system and method

(76) Inventors: Panayiotis Adamos Michael, Los Angeles, CA (US); Michalis Faloutsos, Riverside, CA (US); Benjamin Greenstein, Los Angeles, CA (US); Fotios Konstantinidis, Los Angeles, CA (US); Michail F. Romesis, Los Angeles, CA (US); Petros Zerfos, Santa Monica City, CA (US)

Correspondence Address: FISH & RICHARDSON, PC, 12390 EL CAMINO REAL, SAN DIEGO, CA, 92130-2081, US

(21) Appl. No.: 10/884,859

(22) Filed: Jul. 1, 2004

Related U.S. Application Data
(60) Provisional application No. 60/483,952, filed on Jul. 1, 2003.

(51) Int. Cl. G06F 7/00

(52) U.S. Cl. 707/104.1

(57) ABSTRACT

A system of delivering personalized streaming content to a destination based on automatic detection of context. A thin stream gateway delivers content to all devices in range, where the range is intentionally limited. Bidirectional communication is established between a fixed and a mobile gateway. The mobile gateway deduces its location from the streams received by the fixed gateway. The mobile gateway provides personal information to the fixed gateway. Handoff between gateways is also supported. The gateways can also form a blanket, that can be used to support ad hoc communication.

### CROSS-REFERENCE TO RELATED APPLICATIONS

This application claims priority to U.S. Provisional Patent Application No. 60/483,952, filed Jul. 1, 2003.

### BACKGROUND

Advertising may be carried out in many different media. One particularly effective technique of advertising individualizes the advertising content to the market receiving the advertising. For example, television advertising often selects the advertising based both on the time of day, and the kind of show that is accompanying the advertising. This way, the person who sees the advertising is likely to be the kind of person who is particularly interested in the item being advertised.

Advertising has also been used in other media, such as bank machines, and the like. Advertising on shopping carts, such as those which will be used in a grocery store or other kind of store have also been suggested.

Current trends in marketing may establish communication between the customer and the supplier.

### SUMMARY

The present application describes a context sensitive streaming system, that provides streaming services of information that are individualized based on detections of context. In an embodiment, the context may be determined based on the receiving and/or listening of streaming information from the neighboring environment. An embodiment enables this streaming information. In addition the system enables bi-directional multimedia communication in real-time in a one to one, or in a one to many, or many to many fashion. An embodiment describes context sensitive advertising, used within retail establishments such as a store.

A specific aspect includes interactive display of informational video, entertainment-in video form, news—in video form, sports, commercials, bi-directional communication such as chatting, videoconferencing commercials at a moment the user approaches a specified product.

### BRIEF DESCRIPTION OF THE DRAWINGS

These and other aspects will now be described in detail, in reference to the accompanying drawings, wherein:

FIG. 1 shows a basic block diagram of the system as used in a store;

FIG. 1A shows a block diagram of a generic thin stream gateway;

FIGS. 2 and 3 show two different exemplary connections of the TSG;

FIG. 4 illustrate the way that the thin stream blanket architecture works;

FIG. 5 actually shows the stream blanket;

FIG. 6 shows network coverage of the blanket;

FIG. 7 illustrates how the TSG and the blanket can be used to extend coverage of the wireless network;

FIG. 8 illustrates handoff between different micro cells;

FIG. 8A shows the real-time stream module architecture;

FIG. 9 shows a hierarchy for managing the different information obtained by the TSG;

FIG. 10 shows the synthesis engine that determines synthesizing different information together;

FIGS. 11-13 show the architecture for incoming streams and/or streams from various modules and detecting the priority of those incoming stream;

FIGS. 14 and 15 illustrate how the content can be displayed on the video screen;

FIG. 16 shows a snapshot of the user interface; and

FIG. 17 shows a diagram of a virtual store defined by different TSGs.

### DETAILED DESCRIPTION

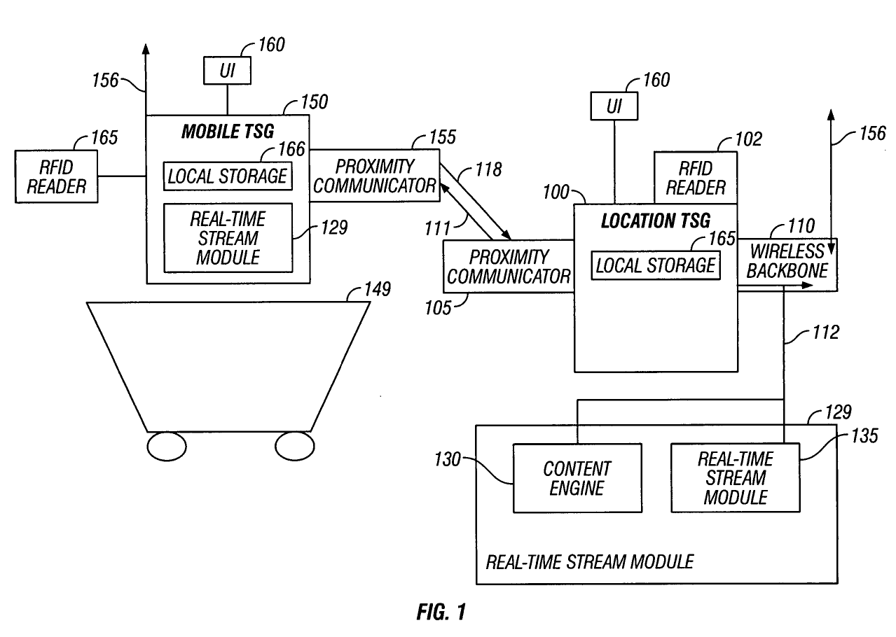

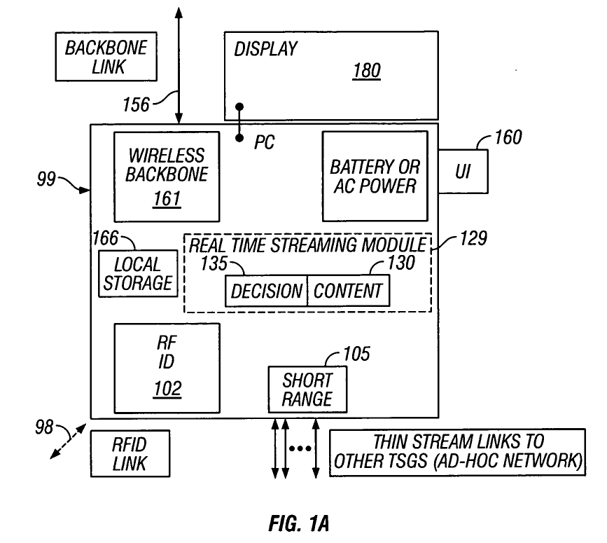

A block diagram of the overall embodiment, showing the different elements is shown in FIG. 1. Multiple thin stream gateways are arranged to communicate with one another. Each of these thin stream gateways receives and/or sends information that is based on its context, e.g., its surroundings and/or personalization information. Unlike other systems that track the location of the customer, an embodiment bases the proximity estimation to the product based on the receiving/listening of streaming information from the neighboring environment location of the product.

A first kind of thin stream gateway (“TSG”), referred to herein as a location thin stream gateway 100, is located on a shelf in a store in proximity to products. The products may be associated with remotely readable identifying devices, e.g. may be RFID tags, or may be other similar tags that can be automatically read to obtain location context. The device deduces its context by reading the tags.

A proximity communicator 105, communicates with other gateways which are within range. Different short range communication standards may be used. For example, this may use Bluetooth communication, Zigbee/802.15.4, low-power embedded systems such as that in Crossbow Mica2 mote, radio, infrared, laser or other optical communication which may be line of sight, ultrasonic communication, or wired communication. Another possible communication can be via Ultra Wideband radio. This technology may allow transmitting digital data over a wide spectrum of frequency bands with very low power The Federal Communications Committee has regulated that UWB signals are transmitted in an unlicensed spectrum, beginning at 3.1 GHz and ending at 10.6 GHz. See, Federal Communications Commission: “Revision of Part 15 of the Commission's Rules Regarding Ultra-Wideband Transmission Systems”, First Report and Order, ET Docket 98-153, 04-200.

The location gateway also includes a streaming interface 110 which receives content 112 that is provided by a content engine 130 over the backbone network. A stream module decision engine 135, may use the context information to determine the kind of content to be received and or sent by the location gateway 100. Both the content engine 130, and/or the decision engine can be part of a time streaming module 129. Moreover, either or both of those modules can be any TSG, or remote.

The mobile thin stream gateway 150 is shown in FIG. 1 as being attached to a shopping cart 149. It can be used in other mobile applications such as automobiles or other vehicles, or as a personal device.

The mobile gateway 150 includes a proximity detector 155 which communicates with the location TSG 100. The module can have similar structure to TSG 100.

A user interface 160 may include a keyboard allowing personalization. In addition to, or as an alternative to the keyboard, an automatic reader 165 may read a specific identification card that is held by the user of the shopping cart, e.g., a readable (RFID or the like) card, or a scannable card, or the like. The personalization may alternatively be input from a mouse, biometric scanner or barcode reader.

The mobile unit 150 may operate in a personalized mode in which personalization information 156 is stored. The user can select the amount of privacy, including whether this information should be sent to the fixed thin stream gateways 100 as part of the context. That personalization information is used by the decision engine 135 to determine the streaming content to be sent. For maximum privacy, mobile thin stream gateway 150 may operate as a listener only, and receive streamed content 111 from the location unit 100.

In a caching mode, the multimedia content is stored in the mobile gateway 150, within a storage unit 166 such as a hard drive. In this case, many different kinds of content may be stored within the client prior to the customer using the system.

In a real-time streaming mode, the multimedia content is streamed, over either the thin stream connection such as shown by 111 or the wireless backbone connection shown by 156. Combinations of the modes may also be used, where part of the data is streamed, and other parts, e.g., the high bandwidth parts, are read based on information in the cache.

This embodiment may therefore use a combination of statically and dynamically updated content. This technique allows the system to be updated in real-time, thus providing the customer with context sensitive personalized content. However, multimedia content can also be cached, allowing more effective use of the network bandwidth.

A number of location fixed gateways typically cover each area, with the mobile gateway 150 receiving streams from the closest gateways.

Each of the TSGs may be formed of identical hardware. A block diagram of an exemplary TSG is shown in FIG. 1A. Each of the TSGs are initially generic, but can be configured as described herein. Each TSG may include a display part 180 that provides content to be viewed by the user or alternatively the unit may be displayless. As shown in FIG. 1A, the TSG shown as 99 includes an RFID reader 102 which reads over the RFID link shown as 98. FIG. 1A shows both the content engine 130 and the decision engine 135 being resident in real-time streaming module, e.g. in software within the device. The TSG also includes the proximity communicator shown as a short range communicator forming short range communication but also includes a connection to a backbone 112. A wireless network card 161 can be used to connect to the backbone 112. The thin stream gateway of the embodiment is shown implemented based on a PC unit with local storage 166. Alternatively this can be other kinds of computers, such as a notebook or a PDA or other personal computing device. In addition, PC boards can be used such as the PC/104 can be used. PC/104 offers full architecture, hardware, and software compatibility with the PC bus, but in ultra-compact (3.6″×3.8″) stackable modules.

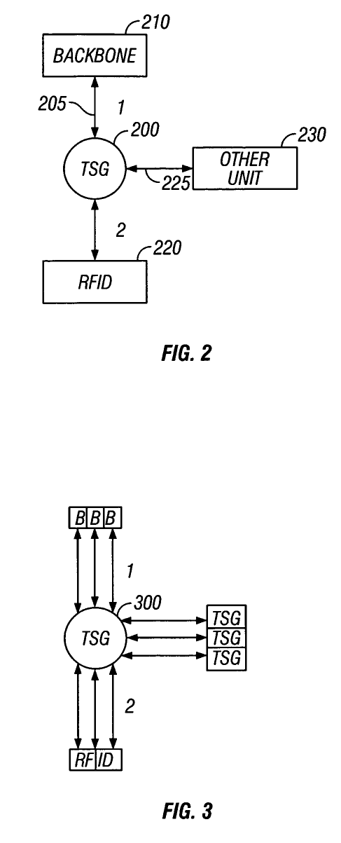

FIG. 2 shows the connections to the gateway 200; including a first connection 205 to a backbone 210, a second port which receives an RFID reader 220, and a third connection 225 to other gateway units 230. Any of the connections can be either a wireless or a wired connection. The backbone 210 is preferably itself connected to a high-bandwidth link.

FIG. 3 shows an alternative connection where the thin stream gateway 300 is itself connected to multiple different units. Each of the connections in FIG. 3 are to multiple units but it should be understood that each of the thin stream gateways can be connected to one or many backbones, one or many RFID units and one or many other thin stream units. In addition, each of the connections can be wireless or wired as needed for the specific application.

In an embodiment, the Thin Stream Gateways are implemented by “sensor motes” commercially available from Crossbow Technology, Inc.

These are battery powered devices running TinyOS, with expansion card capability. These devices support two-way mesh radio networks. Also, a sensor and data acquisition expansion card can be added, to allow direct sensing as well as interfaces for external sensors. The motes can be interfaced to an external terminal, e.g., a PC or PDA.

In a specific embodiment, a mica2 mote is used, connected to its programming and serial interface board (MIB510). The programming board is connected to a laptop via a serial cable. The laptop may run cygwin, a linux-like environment for windows. The mote is operated, as described herein, to generate a packet with a sequence number and an id and can transmit over the mote's CC1000 radio. Packets received on neighboring motes' radios are delivered to the serial port via the mote's UART interface to the programming board. Alternatively, the connection can be via Gateway Connectivity via Wi-Fi and/or RFID connectivity.

The thin stream gateway 100 may bridge between a high-bandwidth communications network, such as ethernet or Wi-Fi (802.11), and operate over multiple different thin stream links. A Thin Stream gateway is a router in the sense that it can receive thin streams, send thin streams, generate thin streams, and process thin streams.

A structured form is used, in which the name is a concatenation of the area plus store plus any other known information.

In an embodiment, a special naming technique is used, called a Context Sensitive naming scheme. Each tag is named in the form:

Country/Region/StoreChain/StoreIdentifier/Product/Br and.

An example RFID tag, therefore, might be named:

/US/CA/Chain1/Store1/Beverages/Cola_Brand1.

An alternative form is simply an artificially generated alphanumeric sequence.

An embodiment sets up the TSG of FIG. 1a with:
(1) a Wi-Fi link,
(2) a low-range communication link, and
(3) an RFID read/write link. In a retail store with an installed a Wi-Fi network.

Each of the TSGs are allowed to automatically configure themselves.

A number of TSGs are placed at areas in the store, e.g., with one TSG near each item of interest.

Each TSG automatically identifies itself within the context of the store. Each TSG may have a context reader. For example, in the embodiment, an RFID reader reads RFID tags that have been put on products or shelves. Each RFID tag represents the items that are on the shelf. This enables the reader to determine the closest objects.

The TSG gateway may carry out context sensitive naming, by reading information from the tags that are within range and using that information as context information, to automatically determine its function. For example, by reading tags and determining that the unit is within the midst of a number of items of product x, the unit configures itself to be a context-sensitive gateway for product x. Context can also be interpolated.

As an alternative to the context sensitive naming, the TSG can be explicitly named, or named by listening to surrounding thin streams.

The short range communication is used to derive coarse proximity estimates used as part of the context. The specific communication is modeled, and a model is formed that relates distance to bit error rate or other reception characteristic. Each received packet of information received via a thin stream transceiver is processed using the model, to find likely transmission strength and range and bit errors, to conclude a coarse radius from within which the information originated.

The radio range of the CC1000 device at default power is approximately 150 ft. That can be reduced to about 30 ft by transmitting at its lowest power, and reduced further by shortening the attached whip antenna from approximately 7 inches to 2 inches. The antenna modification creates an impedance mismatch that reduces the ability of the radio to receive messages. Hand-tuning of the transmission range can be further modified by bending and folding the antenna.

Each TSG may carry out proximity estimation TSGs by repeatedly streaming IDs, sequence numbers and other context such as price of product information every 2 seconds. A circular array of the last 7 streams received may be maintained. Because of the reduced radio transmission range, any ID found in the window likely refers to an ID that is physically near, e.g. within 10 ft of, the receiving TSG. The distribution of IDs in this window are examined, and the ID that appears the most times may be adopted.

Other ways of determining distance can be used. For example, the received signal strength indicator (RSSI) can be correlated to distance to more accurately characterize proximity. Other proximity estimation techniques can be used, including ultrasonic acoustic localization, or other RF localization techniques that involve SNR (Signal to Noise Ratio), time based methods including TDOA (Time Distance of Arrival), ToA (Time of Arrival) of acoustic, ultrasonic, infrared (IR), and radio frequency (RF) waves. Furthermore, other techniques for estimation that use statistical methods such as least squares estimation, probability models such as Bayesian belief models and Markov chains, and physics-based technique such as spring relaxation and entropy reduction, may be used to determine more information about the positions from the received, signals.

A empirical model can be derived investigating the fraction of streams that had been sent that were correctly received. This fraction can be ascertained based on the sequence number of each stream.

Specifically the product proximity may be determined as follows:
set transmission ratios Xft

Any packet received is within the proximity with radius Xft with great probability.

The packet from Proximity Sources has a structure of:

<Stream ID: US/CA/Chain1/Store1/Cola1, Sequence No: 3, Value:Current Price, Value:Other Info, . . . >

1. Create a set of the last N packets received as Last_N_Packets Set implemented as a circular array (window).

2. Create a set of the Unique StreamIDs from the last N packets as Unique Stream Set: <Stream ID1, Stream ID2, . . . >

3. For each of the Stream IDs in the Unique Stream Set estimate the number of its occurrence as Occurrence in the set Last_N_Packets.

4. For each one of the Stream IDs of the Unique Stream Set estimate the ratio Probability Of StreamID as its Occurrence divided by the number N of the last packets received.

5. Create the Set of the Unique Stream IDs associated with their Probability_Of_StreamID.

6. Individual proximity is the Stream ID with the maximum Probability_Of_StreamID. In case that multiple IDs have the same maximum Probability_Of_StreamID, enumerate the set and receive the Stream ID with the maximum Probability_Of_StreamID and lowest enumeration index in the set.

Different gateway configurations are contemplated.

Proximity may also be deduced according to rules.

The rules may say, for example, that if a packet is received by a receiver, then with great probability the receiver is closer to the sender then the experimentally derived upper bound on the transmission radius, the distance D1.

A receiver that hears from two senders is with great probability within the intersection of the transmission regions of both senders.

A receiver that hears from some but not all of a set of sequenced packets from a sender can further refine its distance-to-sender estimate by computing the percentage received and loosely correlating that percentage to a curve that maps distance to probability of reception.

A receiver that hears some packets from each of a few senders can use the distance estimates computed above to trilaterate for more precise localization.

Environmental factors such as RF noise, reflections, and obstacles can make the actual relationship between signal strength and distance non-monotonic. A model or graph of these variables may be maintained. Distance-to-sender estimates can be used to trilaterate information.

Proximity estimation techniques may be augmented by information gathered over time. Given a probability distribution at time t0 of a mobile node being at location (x,y) and a probability distribution of the speed of movement of the node, a new probability distribution of location can be derived at time t1. This distribution can then be combined with one derived from beaconing to form a more accurate location, and hence a proximity estimate.

Proximity estimation techniques can allow the receivers in the gateways to ascertain the context of their physical location. Enhanced by context information, proximity estimation leads to context localization. The context sensitive naming scheme provides a way to provide this context information. The context localization does not require absolute locations, but rather operates based on information about context.

For example, the context localization may realize that it has read 400 tags for soup and only one tag for milk. From this, it can infer that it is near the soup display and not the milk display.

Different kinds of information can be obtained from this context localization. For example, the context localization may be used to determine how different kinds of customers travel through different aisles, how long they spend, and relationships between the times that they spend in different aisles.

Each of the TSGs may be allowed to automatically configure themselves based on the localization. A number of TSGs are placed at areas in the store, e.g., with one TSG near each item of interest. Each TSG automatically identifies itself within the context of the store. Each TSG may have a context reader, e.g., in the embodiment, an RFID reader which reads RFID tags that have been put on products or shelves. Each RFID tag represents the items that are on the shelf. This enables the reader to determine the closest objects.

A first Thin Stream Gateway configuration, called TSG1, is a Thin Stream gateway for a router and processor of thin streams only. It can receive thin streams, send thin streams, generate thin streams, and process thin streams. TSG1's are useful for proximity detection, localized streaming, and as part of a routing fabric for multi-hop delivery of streams where the backbone is inaccessible.

A Thin Stream/RFID Gateway—TSG2-RFID, has, in addition to the functionality described for the TSG1, a translation unit that scans payloads coming from a thin stream channel to find RFID control commands, which may be directed to the attached reader. Furthermore, the TSG2-RFID may autonomously choose to issue RFID reader control commands.

A backbone/Thin Stream Gateway is denoted as TSG2-BB. A Backbone/Thin Stream Gateway (TSG2-BB) receives, processes, translates, and transmits stream data emanating from a high-bandwidth backbone link such as an 802.11 link or Ethernet link to a thin stream link or vice versa.

For example, a TSG may deliver a data payload from an 802.11b network to a Mica2 network or vice versa as follows: Any device such as a PDA or laptop, or tablet PC that has a PCMCIA slot, an 802.11b PCMCIA card, and an Ethernet port may serve as the bridge. When this device receives data via its 802.11 card, it can use the IP socket communication paradigm to deliver that data to an application.

A Backbone/Thin Stream/RFID Gateway is a TSG3 device. This incorporates an RFID reader. In addition to the functionality described for the TSG2-BB, this gateway provides a translation unit that scans payloads coming from the backbone or thin stream channels to find RFID control commands, which may be directed to the attached reader. Like the TSG2-RFID, the TSG3 may autonomously choose to issue RFID reader control commands itself.

The TSGs can form a network blanket. A building such as a store may be equipped with tiers of wireless communication technologies. In an embodiment, four tiers are possible.

A first tier is a high-bandwidth wired connection to the Internet. This may carry the backbone information, and may transmit at rates from hundreds of Mbps to Gbps.

A second tier is wireless ethernet, “Wi-Fi”. Any of the several variants of 802.11, 802.11b, which provides speeds up to 11 mbs, 802.11g or 802.11a can also be used. The range for Wi-Fi is typically around 100 to 300 feet indoors and 2000 feet outdoors.

A thin stream tier, carries out a short range streaming, at rates between tens and hundreds of kilobits per second and over ranges of 1-100 feet.

The fourth tier is formed from RFID tags, allowing identification streams that readers can process. These devices operate on the order of hundreds per second, and have transmission ranges between one inch and ten feet.

Nodes can learn their location context and disseminate streams of content by using one or more of these tiers.

A tiered thin stream blanket (TTSB) architecture is used for data dissemination and proximity estimation. Routers/hubs (tier 0) provide a direct connection to the high-bandwidth backbone network. Each building site typically will have one or more tier 0 devices.

Wi-Fi base stations form tier 1 that may communicate the content to the TSGs, which themselves form tier 2. Alternatively, Tier 2 may communicate directly, e.g., via wire connection, to tier 0.

The individual TSGs within the blanket may have bidirectional communication with the 802.11 base stations, with the wired Internet directly, with other TSGs, and with RFID tags. TSGs may communicate with other TSGs via their thin stream channels or via IP communication.

RFID tags (tier 3) communicate with TSGs that are equipped with RFID readers.

IP routing may be used to route information and multimedia content to and from the building site. IP may also be used to transmit data between TSGs that are more than one thin stream communication hop apart.

Thin streams are used for proximity estimation, for spatially scoped (i.e., one hop) delivery of streams, and when necessary to reduce RF emissions (e.g., in hospitals). Furthermore, the TSGs form a secondary routing fabric that can be used for multi-hop communication between TSGs, either when a lack of 802.11 coverage precludes IP delivery or when spatial reuse may be employed to improve aggregate bandwidth utilization.

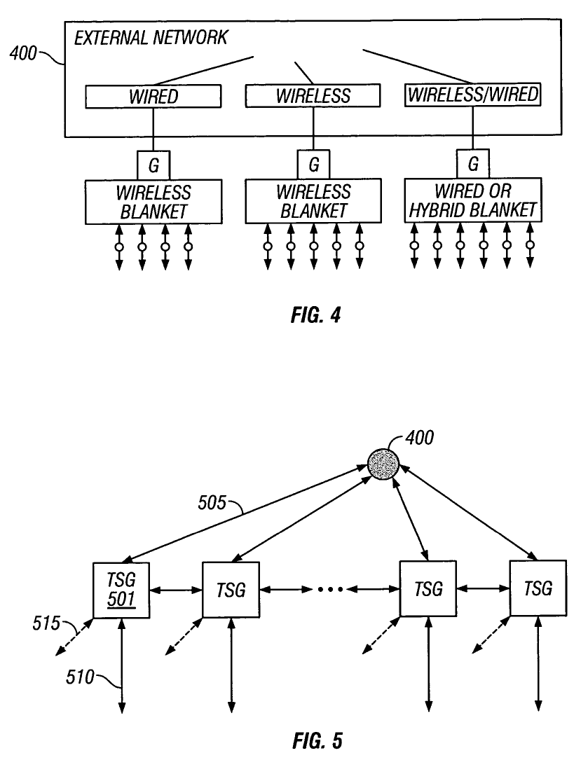

FIG. 4 shows a tiered Thin Stream Blanket architecture. In this embodiment, commercially available Wi-Fi access points are used to form the wireless network inside a store. The access points are placed on shelves and have connection to a store server, for the-connectivity of the system to the internet as well as the remote monitoring and programming of all the components of the system. Different areas can be covered by different parts of the network.

FIG. 5 illustrates the blanket itself, showing the dual network capabilities of the TSGs allow each TSG 501 to receive a wireless transmission 505, and retransmit that or a part thereof, over short range network 510. This can form ad-hoc networks, within the Wi-Fi backbone. The RFID module area reader 515 may provide additional context. Tree routing over ad-hoc wireless networks may also be used, e.g., for delivery of streams over TSGs that are NOT IP equipped. The roots of the routing trees are the closest IP-equipped TSGs to the TSG's without IP. Mintroute is a multihop tree-routing protocol written at Berkeley for motes. Diffusion is tree-routing and data processing protocol written at USC for linux-class devices. It has recently been ported to motes and renamed tinyDiffusion. Tree routing may be used for non-IP multihop communication, or for multihop unicast, multicast, and broadcast. Different routing protocols, such as GPSR, DSR, AODV and DSDV are unicast routing protocols for ad hoc networks. Beacon vector routing is a unicast protocol that is implemented for motes. IP TO MOTE COMMUNICATION can also be done, using existing hardware such as the MIB600 Ethernet Interface board from Crossbow. A solution for communication between an IP-enabled device and a mote via serial is the “Serial-line communication with tinyos”

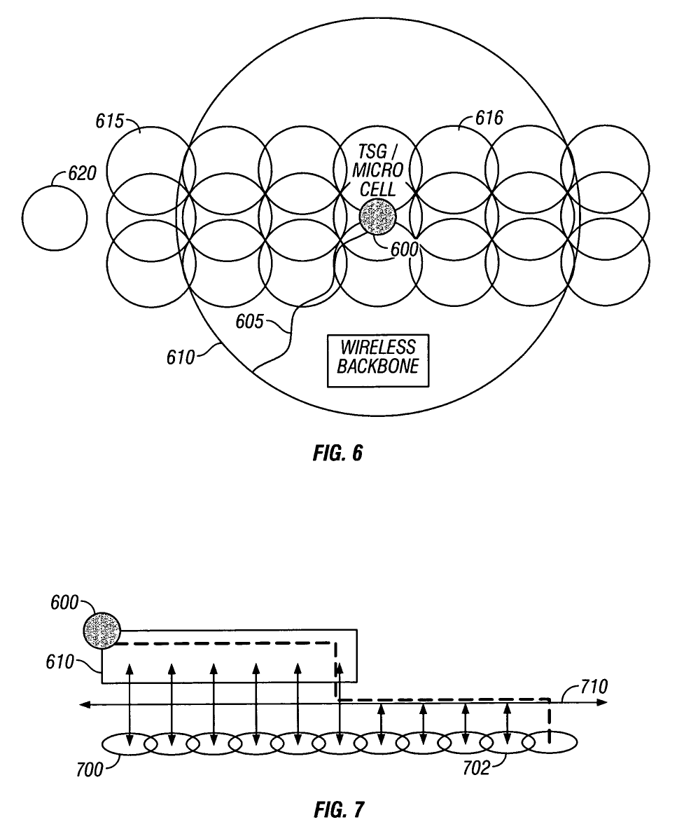

FIG. 6 shows the network coverage of a thin stream wireless blanket, having a single base station shown as 600. That base station transmits Wi-Fi shown as 605, defining a radius 610. Anywhere within the radius 610 is within the wireless backbone. However, a number of microcells, a few examples of which include 615 and 616, are formed both inside and outside the wireless backbone. The microcells may overlap and may be within range of other microcells. Other microcells such as 620 may be separate and not overlapping. Each TSG can therefore communicate, not only with the radius 610, but also with the other TSGs. This allows the TSG 615 to communicate with the wireless backbone even though it is outside the range 610 of the Wi-Fi. This may also be useful in setting and maintaining traffic, especially when the traffic becomes congested. Load-balancing between the TSGs can help to maintain the traffic in this way.

FIG. 7 shows how the thin stream blanket can be used to communicate with TSGs that are outside the area of the wireless backbone. TSGs such as 700 can communicate with the backbone, but TSGs such as 702 are outside the backbone and can only receive the communication over the ad hoc network 710 which is formed between adjacent TSGs.

TSGs can also communicate over the Wi-Fi. For example, interstore video conferencing may be carried out by communicating to the TSGs, over the Wi-Fi 610, and to another TSG.

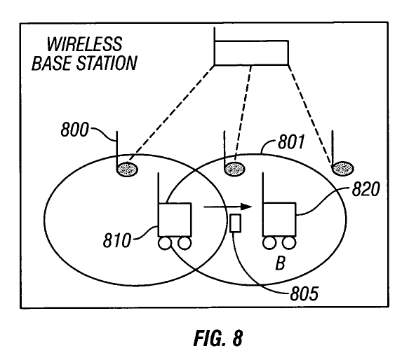

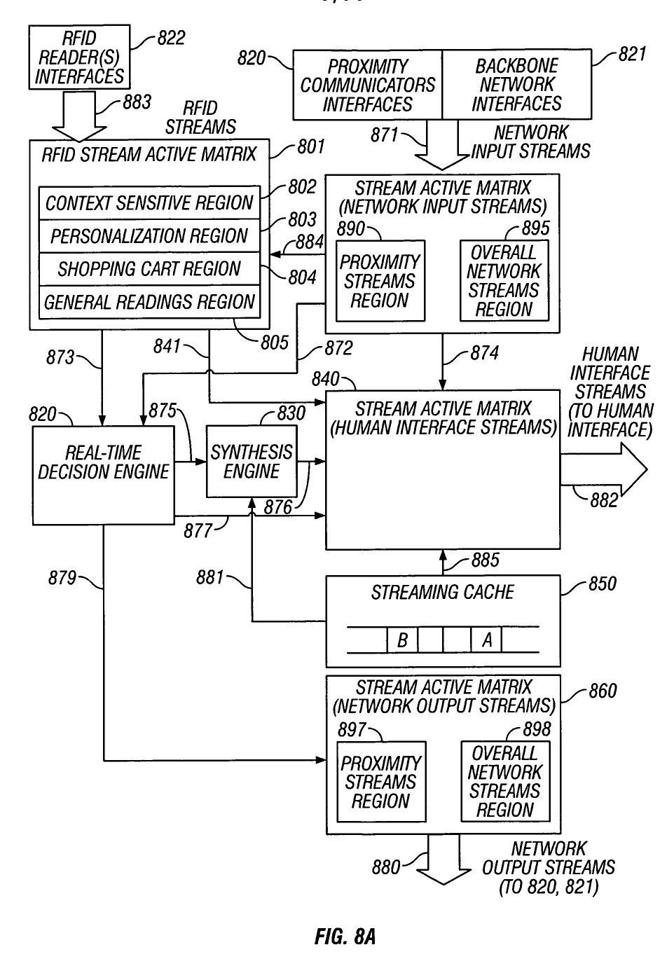

FIG. 8 illustrates the handoff technique which may be carried out between different microcells. In FIG. 8, the user is initially at position 810 within the microcell 800, and is moving to the position 820 within the microcell 801. When the user gets to the position 810, they are in the position where they can communicate with both microcells 800 and 801. The handoff operation begins during that time, and when the user gets to the position 815, the handoff is completed. The user from position A moves to position B. Initially, the user is communicating with the first microcell 800, but is moving towards the second microcell 801. The handoff takes place between the two cells which can communicate either through the wireless backbone or in an ad hoc fashion. During the overlap area, both microcells can communicate with the user but only one does. 801 can proactively prepare for the handoff, but the handoff happens when the user is sufficiently within 801.

Although the above has described four possible tiers that could be used, a preferred embodiment may use a two-tiered system. A first tier may carry 802.11 Wi-Fi, carrying streams of information at data rates of megabits per second and at communication ranges measured in tens to hundreds of feet. A second tier is a thin stream tier, carrying out a short range streaming. This allows Wi-Fi base stations to form tier 0 that may communicate the content to the TSGs. The individual TSGs within the blanket may have bidirectional communication with the 802.11 base stations, with other TSGs via their thin stream channels, or via IP communication.

Note that the Thin Stream Blanket can also cover areas like parking lots, malls and on the area around the store (for customers that are window-shopping). It can also cover areas such as roads, interior of vehicles (cars, buses), airplanes. It can also cover small regions such as furniture.

FIG. 8A shows a block diagram of the communication streams, and the modules that manage the interfaces. The proximity communicator(s) interfaces 820 may be those provided by Crossbow or may be public domain interfaces. Backbone connectivity interfaces 821 may be used for managing parts 871, 880. RFID reader(s) interfaces 822 are provided for management of the RFID module and for managing the RFID streams 883.

The network input streams 871 arrive at the stream module 810 via their respective interfaces: 820 for the proximity communicator interface and 821 for the backbone link interface. The stream active matrix for the network input streams separately handles the proximity streams 890 and the overall network streams 895. The proximity streams 897 are forwarded locally, while the overall network streams 898 are forwarded more globally, e.g. to the internet, the WAN or the LAN.

The RFID streams 883 arrive at the module via their RFID reader interface 822. The streams are forwarded to the RFID stream active matrix 801. If the streams have personal information such as Social Security Number or Credit Card information or a name, they are forwarded to the personalization region of the active matrix 803. Proximity streams can also have personalization information, which are forwarded to personalization region 803 via the link 883. Any context sensitive information such as a product name, sensed environmental information or sensed location, is delivered to the context sensitive block 802 of the matrix. The code itself can include information about the type (personal or product) to guide the system or the system itself can decide (e.g. based on the number of digits or the format of the codes). Proximity streams can have context sensitive information (that are based on listening to the proximity streams content and receiving content regarding their context and/or their IDs) and are also forwarded to 802 context sensitive region via the link 883.

If the TSG is configured to distinguish the RFID tags from within the shopping cart, products picked by the customer, the respective RFID streams are forwarded to shopping cart region module 804. The distinction can be done with different methods. For example, this can use multiple RFID readers, different antennas. For example, one may be mounted at the bottom and walls of the cart. There may be different coding for context sensitive information than for products or adding an additional code on the RFIDs of products placed in the cart.

The Real-Time decision engine 820 reads information from the stream active matrix 810 via the link 872, and from the RFID stream active matrix 810 via the link 873. It determines which streams to forward to the human interface streams active matrix 840 via the link 877 or to the synthesis engine 830 via the link 875 or to the 860 network output streams stream active matrix via the link 879. The streams are forwarded to the proximity streams module 897 for delivery to the proximity recipients through the proximity communicator interface or to the overall network streams module 898 for delivery via the backbone link.

The routing information may be decoupled from the stream naming. An association table is formed from the routing system to associate the logical unique identification to routing information for delivery via the IP addressed network or via the ad-hoc network or via a combination of the two.

The streaming cache 850 is accessible from the LAN or WAN or the internet whenever a high-bandwidth path is available (e.g. via the backbone link or via a high-bandwidth proximity communication or via a route within the thin stream blanket). The streaming cache 850 caches multimedia content to be used upon request. FIG. 8A shows two versions denoted as an example, version A of a video and version B of a video.

The synthesis engine 830 synthesizes the streams of the streaming cache 850 and the streams forwarded by the real-time decision engine 820. The synthesis instructions are included within the network input streams 871 and are forwarded to the synthesis engine 830 by the real time decision engine 820. The human interface stream active matrix receives streams from the synthesis engine and/or from the real-time decision engine and forwards their content to the human interface module. The human interface streams can thus include actual content from the streaming cache or the active matrixes forwarded to it or pointers to the streaming cache location of a specific multimedia content (e.g. pointer to video B) or pointers to actual address locations of the active-matrixes.

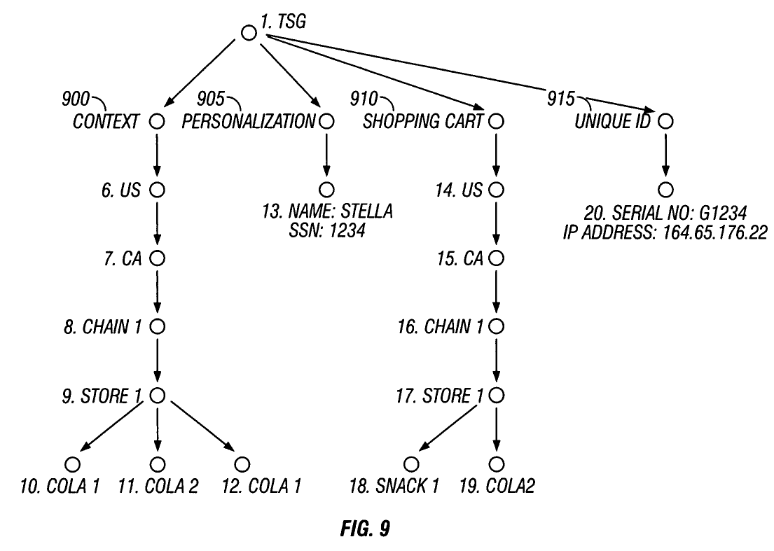

Context estimation can be based on estimating the probability of having a specific Context. Each stage has the result for the context in FIG. 9.

1. For all paths under the node Context.

Create the set of all leaves LEAVES. The LEAVES defining the different items which have been detected from context. FIG. 9 shows how the context may include different items. A first set 900, of context, defines the context from the store, specifically the locally created context for a TSG on the shelf. A second set, 905 defines personalization which may be information that may be maintained secret, or may be allowed to pass. The personalization can include, for example, the user's name and the like. The shopping cart set 910 may refer to the location of the shopping cart. Finally, a unique ID information 915 can refer to the user's unique ID and IP address. Any of these items can be used as LEAVES.
result: LEAVES ={COLA1, COLA2, COLA1}

2.Count the number of elements in the set LEAVES as TOTAL_NUMBER_OF_LEAVES.
result: TOTAL_NUMBER_OF_LEAVES=3

3. Create the set of all unique leaves UNIQUE_LEAVES
result: UNIQUE_LEAVES={COLA1, COLA2}

4. For each element in the set UNIQUE_LEAVES, count its occurrence in the set LEAVES, and store it in the set OCCURENCES along with the leaf's name.
Result: OCCURENCES={2:COLA1, 1:COLA2}

5. For each one of the unique leaves Divide its OCCURRENCE with the TOTAL_NUMBER_OF_LEAVES as participation. Store each participation in the set PARTICIPATIONS along with the name of the respective leaf.
Result: PARTICIPATIONS={0.67:COLA1, 0.33:COLA2}

6. Receive as the MOST_PROBABLE_CONTEXT the leaf name from the set PARTICIPATIONS with the maximum participation value.

Result: MOST_PROBABLE_CONTEXT: COLA1

When the maximum participation value belongs to multiple members of the set, the one with the highest position in the set can be provided, or some other technique can be used, such as random selection etc.

In general the result above is adequate to provide a probabilistic context estimation such as (67% Cola1, 33% Cola2).

The same technique can be applied for the personalization and shopping cart cases.

An example of a structured context sensitive ID can be used. The structure can be transformed into an XML document. XML documents can be queried via various known methods such as the “Quilt” xML query language.

Readings on the shelves of a store /US/CA/Chain1/Store1/Cola1 and /US/CA/Chain1/Store1/Cola2 can be stored as paths 1, 2, 6, 7, 8, 9, 10 and 1, 2, 6, 7, 8, 9, 11. The sub-path 6, 7, 8, 9 is common for the two readings. Hence, this localization can be used to cluster together all the products where customers are currently nearby, e.g. under the Store1 node. Alternatively the structure may create two different paths, one per RFID.

The leaves of the structure are different per RFID reading. Even for two items of the same product (in this example two items of the product Cola1 with RFID /US/CA/Chain1/Store1/Cola1), two different LEAVES are created. This may avoid reading conflicts and also allow operation with RFIDs that do not follow the proposed naming scheme. It also works with RFID readers that are susceptible to reading errors or cause redundant readings.

Alternatively, the system allows no personalization, or usage of a generic name or nickname or usage of a keyboard or other method described in <section>. In the case that the person has a personal device that allows the his/her identification with the unit, the reading is done and stored in the proximity streams region in a similar personalization sub-region. The Unique Context Sensitive ID of a TSG remains unchanged in any case.

The same technique applies for the reading of the product information within the shopping cart.

An example scenario is the one where a new TSG, say TSG1, is placed on a shelf at Store1 near the Cola1 products. The TSG recognizes its context and receives an IP from DHCP server of the thin stream blanket in the store. The TSG creates its context sensitive ID which includes routing information, e.g. the blanket's gateway IP and its own IP message.

The Cola1 representatives query the blanket gateway for all of the devices it supports. The blanket gateway sends out all the context sensitive IDs for the TSGs deployed in the store.

The Cola1 representatives choose to start streaming content-to the TSG1, TSG. The TSG1 via its proximity communicator, streams special pricing to the nearby (personalized to customers) TSGs. A similar scenario occurs when the Cola1 representatives choose to stream content to a set of TSGs that prefer e.g. TSGs near the Cola1 products or TSGs near complementary products such as snacks.

As described above, a specific TSG can be close to product1 with probability 70% and close to product2 with probability 30%.

As an alternative, the same TSG can belong to a group of 4 persons (say a family) where 75% are male (father and two children) and 25% are female (mother). In addition the specific TSG can identify in the shopping cart and store in its context sensitive ID 70% of various brands of juices, 30% cereals and someone can assume that its time for the family to buy milk. Milk companies can send content to the TSG via its IP routing information included in the ID as a reminder. The customer can disable this kind of communication at any time.

The group personalization can be used to create a new business paradigm in clubs, restaurants, movie theaters, airplanes, coffee shops and in general in areas that audiences gather where the content can be determined dynamically based on the demographics of the audience in real time. The percentages of male or female, the distribution of ages and the personal profile, preferences of the audience transmitted based on proximity communicators or RFID technology (or entered by keyboard or other input devices) can determine in real-time the content sent to a TSG with a large screen and satisfy the majority of the audience.

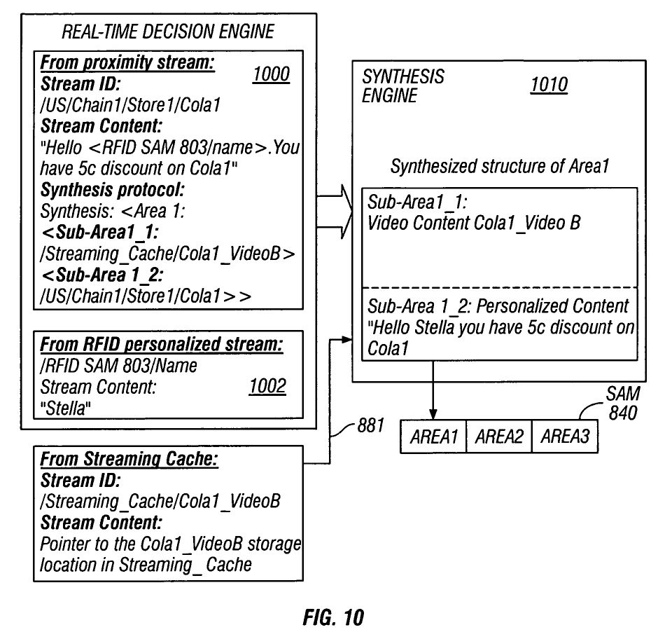

FIG. 10 shows the Real-Time Decision Engine which Information 1000 from the proximity stream and Information 1002 from the RFID SAM 803 is sent to the Synthesis Engine 1010.

The proximity stream may be arranged via a synthesis protocol. Based on the protocol the proximity stream guides the Synthesis unit to create a structure Area1 with two sub-structures Sub_Area1_1 and Sub_Area1_2.

Sub_Area1_1 receives streamed content from the /Streaming Cache/Cola1_VideoB. The Synthesis Engine uses the cached content of the Streaming Cache by using the pointer associated with the /Streaming_Cache/Cola1_VideoB. The synthesis engine synthesizes the name from /RFID stream here Name, “Stella”

With the streaming content from the proximity stream /US/Chain1/Store1/Cola1 , “Hello <RFID SAM 803/name>. You have 5c discount on Cola1”. The end result is a streaming content “Hello Stella. You have a 5c discount on Cola1” which is streamed in Sub-Area1_2.

The end result is the creation of a real-time personalized video. In this embodiment, this may also include the real-time generation of a coupon.

Notice that though the content is highly personalized, no personal information is disclosed to the proximity network or other network. The name “Stella” is used from the stored in the personalized mobile TSG of the user. This forms an additional level of privacy protection.

In addition, even if the content is highly personalized and at the place and time of the decision of the user to shop (in a retail example), the system cannot realize or monitor the existence of the customer who is solely in a listening mode.

The advertising window is divided into two sub-areas. Sub-Area 1 and Sub-Area 2. The two areas receive streaming information from two associated stream sources.

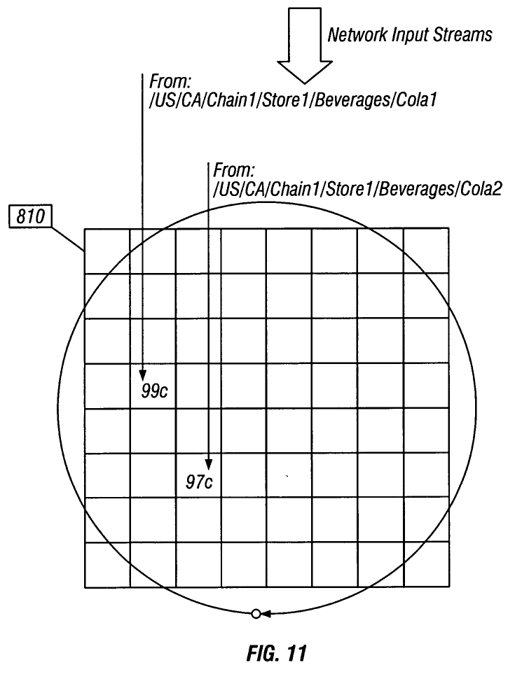

FIG. 11 illustrates Stream Active Matrices thus can be implemented either as an array or a list (or a list of lists in a recursive manner). The Stream Active Matrix de-multiplexes the incoming network input streams to its constituent streams, uniquely identified via their Stream ID and at stores the value at each moment at a specific memory or physical location in the matrix. A new value from the same stream overrides the old value in a continuous streaming value.

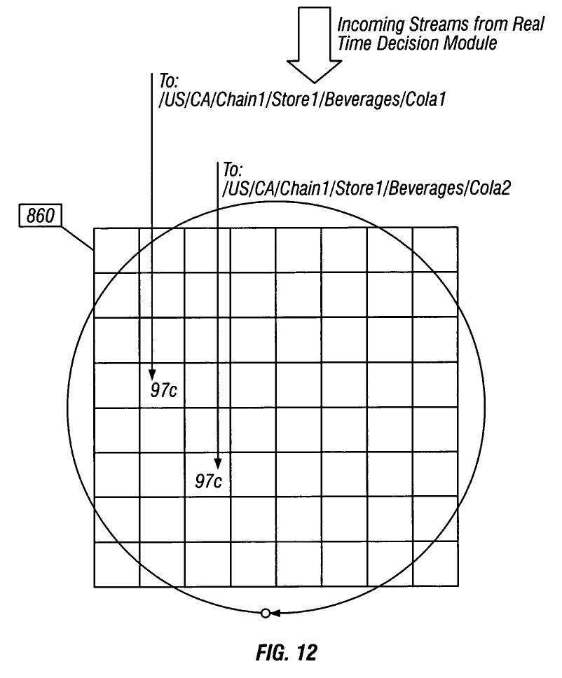

FIG. 11 shows two streams: The /US/CA/Chain1/Store1/Beverages/Cola1 stream with value 99c and the /US/CA/Chain1/Store1/Beverages/Cola2 with value 97c. As an example, at the next moment the /US/CA/Chain1/Store1/Beverages/Cola1 can stream the value 97c overriding the value 99c. The stream active matrix in that case would then have two values of 97c stored in the respective unique stream locations as shown in FIG. 12.

The 860 stream active matrix at each moment stores the values that will be streamed to the specific destinations. The active matrix has two regions. The figure shows an example where a mobile TSG broadcasts to its proximity the best price it has received from a negotiation process. The 860 stream active matrix can refer to memory locations of all the active matrixes and the streaming cache in the system for communication purposes.

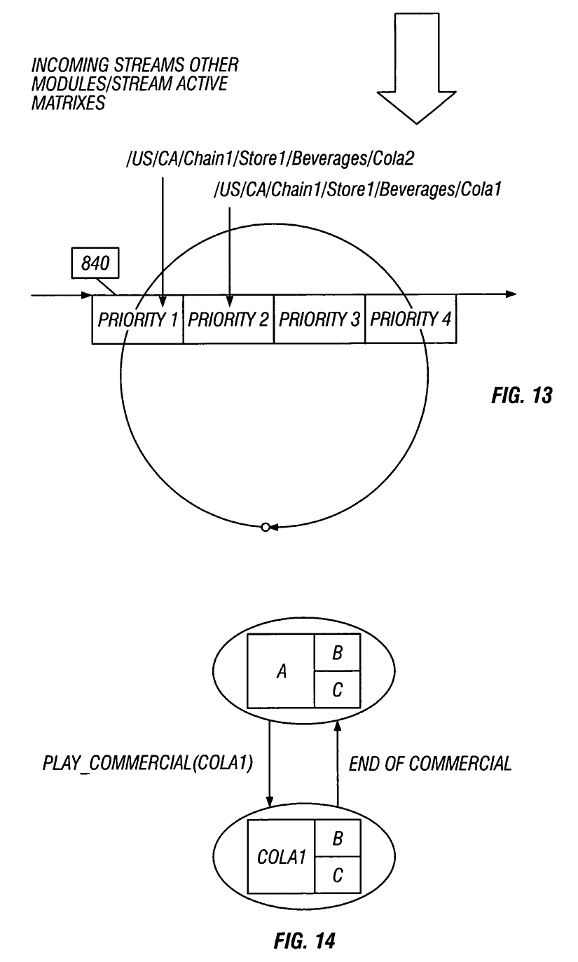

FIG. 13 shows more details of this technique of priority based on price.

The Stream Active Matrix may be implemented as a list as shown in FIG. 13. Each location in the list defines a priority for the respective stream.

These automated priorities might not be the ultimate decision point. A second level of decision making is done by the human interface module which takes into consideration the customer preferences (touch screen, or mouse clicks) and determines a window.

EXAMPLES OF REAL-TIME DECISION LOGIC FOLLOWS

```
  WHILE (CONDITION=TRUE) /* REPEAT CONTINUOUSLY */
  {
  IF (PRICE FROM THIN STREAM OF COLA 1 < PRICE FROM THIN STREAM OF
COLA 2 ) /* FROM 810 REGION 890 */
  THEN
  {
  DECISION1= “DISPLAY IN HUMAN INTERFACE PRIORITY 1 WINDOW THIN
STREAM OF COLA 1”;
  DECISION2 = “DISPLAY IN HUMAN INTERFACE PRIORITY 2 WINDOW THIN
STREAM OF COLA 2”;
  /* SENT FROM THE REAL-TIME DECISION ENGINE 820 TO STREAM ACTIVE
MATRIX 840 WITH POINTERS TO THIN STREAM OF COLA 1, THIN STREAM OF COLA
2 - COMMUNICATION VIA LINK 874. THE DECISION MODULE IN THIS CASE ACTS A
SWITCH OF THE INCOMING STREAMS TO THE VISUALIZATION DISPLAY OF THE
CUSTOMER BASED ON THE REAL TIME DECISION LOGIC */
  EXECUTE DECISIONS;
  }
  } /* END OF WHILE;
```

Proximity Communication

The proximity communication can set various information based on listening or communication between two parties.

Proximity Price Listening.

1. Listen to Prices of proximity static TSGs by scanning the stream active matrix 810 (region 890) once.

Variation for continuous execution

1. While condition (temporal or other condition, “while I'm moving”, For 3 seconds, continuously etc.)

2. Execute Proximity Price Listening algorithm

3. Repeat 1.

Proximity Coupon Listening.

1. Listen to Coupons of proximity static TSGs by scanning the stream active matrix 810 (region 890) once.

Variation for Continuous Execution

1. While condition (temporal or other condition, “while I'm moving”, For 3 seconds, continuously etc.)

2. Execute Proximity Coupon Listening algorithm

3. Repeat 1.

Real-Time Pricing can Include the Generation of Pricing in Real Time Based on Various Factors.

1. LISTEN FOR PRICES FROM PROXIMITY STATIC TSGS BY SCANNING THE STREAM ACTIVE MATRIX 810 (REGION 890) ONCE.

2. DISCLOSE PERSONAL INFORMATION TO THE PROXIMITY (E.G. EXISTENCE, PREFERENCES, ESTABLISH COMMUNICATION)—USING 897 IN ARCHITECTURE.

3. LISTEN FOR PRICES FROM PROXIMITY STATIC TSGS BY SCANNING THE STREAM ACTIVE MATRIX REGION 890 ONCE/* EXPECTS THAT THE PROXIMITY STATIC RECIPIENTS HAVE GENERATED (SPECIAL) PRICING IN REAL-TIME FROM THE DISCLOSED INFORMATION BASED ON THE STATIC TSG TECHNIQUES */

Variation: Carry out steps 1,2,3 listens before it discloses information. Alternatively usage of only steps 2, 3 can be applied.

Variation: Real-Time Price Negotiation.

When 2 has a form of

2a. Disclose personal information and/or price received by all parties—using 897 in architecture.

The mobile TSG is negotiating and we refer to the method as Real-Time Price Negotiation.

Variation for Continuous Execution

1. While condition (temporal or other condition, “while I'm moving”, For 3 seconds, continuously etc.)

2. Execute Real-Time Pricing Algorithm.

3. Repeat 1.

Real-Time Coupon Generation.

1.Listen for Coupons from proximity static TSGs by scanning the stream active matrix 810 (region 890) once.

2. Disclose personal information to the proximity (e.g. existence, preferences, establish communication)—using architecture.

3. Listen for Coupons from proximity static TSGs by scanning the stream active matrix region 890 once /* expects that the proximity static recipients have generated (special) coupons in real-time from the disclosed information based on the static TSG algorithm */

Real-Time Coupon Bidding.

Variation for continuous execution

1. While condition (temporal or other condition, “while I'm moving”, For 3 seconds, continuously etc.)

2. Execute Real-Time Coupon Generation.

3. Repeat 1.

Static TSGs Delivery

1. Send Price to proximity /* to a specific recipient or broadcast */

Variation for Continuous Execution

1. While condition (temporal or other condition, while someone communicates, continuously)

2. Execute Static TSGs

3. Repeat 1.

Proximity Static TSG Decision and Delivery

1. Listen to personal information from proximity mobile TSGs

2. Decide on a special price/coupon/incentive

3. Send price to proximity/coupon/incentive to proximity

Variations:

Proximity Static TSG Algorithm, execute once.

Proximity Static TSG Algorithm, execute multiple times in a conditional loop, or in a continuous loop.

Proximity can be the mobile TSGs or all TSGs in proximity.

The streaming cache storage may be managed in a FIFO manner, e.g. by emptying the oldest copies in favor of the newest. The streaming cache has a structure where the video or other multimedia content is associated with a set of valid timestamps (i.e. the validity period of the multimedia content). This may be done by maintaining tables which store records of the form <Stream_ID, From Timestamp, To_Timestamp>.

Example records for the association are
</US/Chain1/Store1/Cola1 VideoA, 08:05 Jan. 5, 2004, 15:07 Jan. 5, 2004>
</US/Chain1/Store1/Cola1_VideoB, 15:07 Jan. 5, 2004, now>

Buffers may be used to hold intermediary or other useful information for the system. The Human Resource State Machines add an additional decision layer to the automated priorities stream active matrix. The display area is separated into different areas with associated priorities based on their size and position on the display. An Automated Window Arrangement is used to get priority.

FIG. 14 shows an AWA State Machine provides an example where 4 video clips A,B,C, and Cola1 are managed by the Human Interface module based on the priorities of the Stream Active Matrix of the Human Interfaces (SAM-HI). The priorities of the clips are set here as A:1, B:2, C:3.

A mobile Unit enters the proximity of Cola1. Cola1 receives priority 1 and is placed at the beginning of the list of SAM HI. The clips A,B,C receive priorities 2, 3, 4 respectively.

A rotation of the screens in a clockwise or anti-clockwise manner causes the video at the lower-right area to be removed from the vision of the user. At the end of the commercial, the original locations of the windows are restored.

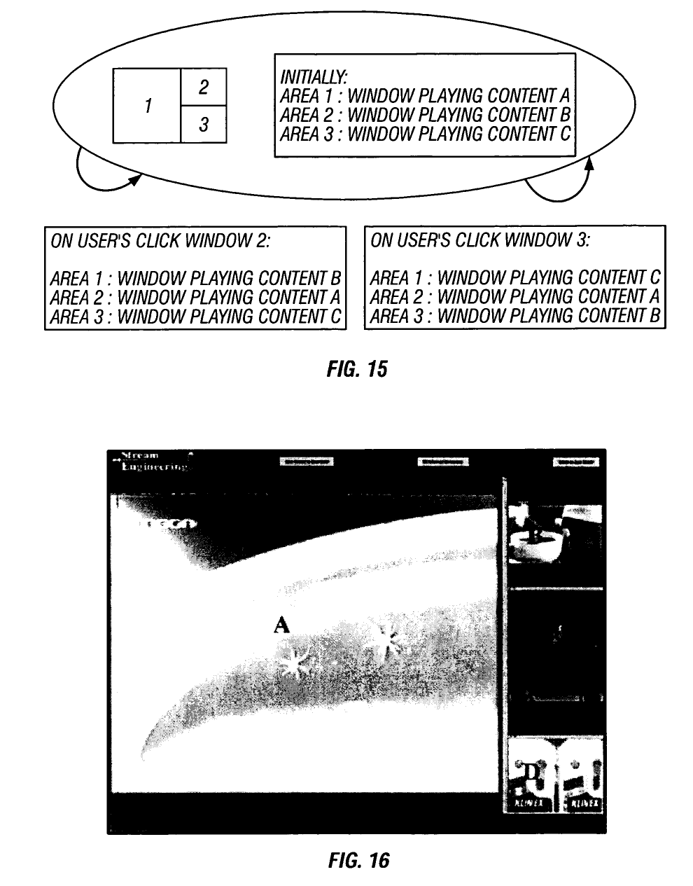

FIG. 15 shows the three windows, Window A, Window B, Window C playing respective Video content, A, B, C. The Windows are located in areas defined by coordinate system locations on the screen identified as Area 1, Area 2 and Area 3.

The numbering of the areas indicates a priority scheme where Area 1 (main, large window) has the highest priority P1 and attracts most of the user's attention, and Areas 2 and 3 have priorities P2 and P3 respectively where priority 2 is higher than priority 3.

The customer can use the user interface to select one of the small windows, called spatiotemporal buttons, to be moved to Area 1. If the customer selects the upper right window (window B in the figure), window A will occupy area 1 while window B will be moved to Area 2.

If the customer selects the lower right window (window C in the figure), then window C will occupy area 1 and all other windows will be moved clockwise to areas with lower priorities.

This shows that the user has given higher priority 1 to content C and its respective window is moved to Area 1, while the priorities of the other two windows are reduced by one. (i.e. A has priority 2 and B has priority 3).

Similar effects can be implemented by moving the contents of the windows and keeping the area of each window fixed instead of moving the windows themselves.

FIG. 16 shows a screen-capture of the output of the Implemented SEUI display. The display includes a main window occupying approximately 75% of the total display area and located on the left of the screen Window A in FIG. 2). Three more windows are occupying the right area of the screen, and are located one on top of the other (Windows B,C,D in FIG. 6).

Different kinds of content can be delivered in this system, to the respective windows.

Commercials are a video clip, e.g. 30 seconds in length, each associated to one of the advertised products are stored in streaming cache of the hard drive.

News content include video clips with news content that are streamed continuously in the streaming cache are stored in the hard drive of the system. These clips are displayed selectively based on the decision module.

Store content includes video clips with advertisements for the store.

Coupons may be static image files stored in a separate streaming cache of the hard drive of the mobile TSG, or may be streamed to the TSG dynamically. Each file is associated with one commercial video clip. The associations are also stored in a streaming cache. The coupons are displayed simultaneously with the corresponding commercial with a message prompting the customer to touch the window of the coupon. When the customer touches the coupon, a discount or similar offer is streamed on the screen.

A real-time ticker has also been implemented which continuously streams information about products and prices. The ticker may be located at the bottom of the display.

A browser may also be used to receive streaming urls from its proximity and displays the respective internet content.

A digital picture viewer for scanned printed material may be used to display in electronic form the retail store's printed catalogue for free or under payment, or magazines and newspapers or similar printed content for free or under payment. The content on the mobile TSG is determined by a decision module. This may include a number of different functions or queries:

Real Time Context Sensitive Pricing may be used to display information about the least expensive product.

Query 1: Display the Synthesized Commercial from the

cheapest Cola
IF { PRICE FROM THE THIN STREAM OF COLA 1 }
IS LESS THAN { PRICE FROM THE THIN STREAM OF COLA 2 }
THEN
DISPLAY IN MAIN WINDOW THIN STREAM OF COLA 1

The Decision Module also facilitates continuous queries that can act as proxy agents on behalf of the customer.

The query determines the best price on product, and displays a commercial for that product. This is shown as the Real Time Context Sensitive Negotiation Procedure

Query 2: Negotiate the best price and inform me through the commercial of the product with that price.

WHILE RECEIVING STREAMS FROM BEVERAGES AND WHILE CUSTOMER MOVING
{
IF (PRICE FROM THIN STREAM OF COLA 1 < PRICE FROM THIN STREAM OF COLA 2
)
{
DECISION = “DISPLAY IN MAIN WINDOW THIN STREAM OF COLA 1”;
ELSE
DECISION = “DISPLAY IN MAIN WINDOW THIN STREAM OF COLA 2”;
}
BROADCAST DECISION;
}

The various queries can also be enhanced with information from the customer's profile. For example, the customer may exclude certain products even if they are the least expensive, in which case the decision may include:
UNLESS PRODUCT IS ON CUSTOMER'S IGNORE LIST

The following demonstrates a Real-Time Bidding procedure enhanced with customer's profile:

Real Time Context Sensitive Bidding Procedure

Query 3: Receive the best coupon via a bidding process and inform customer through the commercial of the product with the highest coupon. Inform the bidders about customer ID and profile.

WHILE RECEIVING STREAMS FROM SNACKS AND WHILE CUSTOMER IS MOVING
{
COMMUNICATE TO THE STREAMS THAT :
“I AM GEORGE GOODCUSTOMER WITH ID=12345 AND I LIKE SNACKS”.
IF
(COUPON FROM THIN STREAM OF SNACK1 MORE THAN COUPON FROM THIN STREAM OF
SNACK2 )
{
DECISION = “DISPLAY IN MAIN WINDOW THIN STREAM OF SNACK1”;
ELSE
DECISION = “DISPLAY IN MAIN WINDOW THIN STREAM OF SNACK2”;
}
BROADCAST DECISION;
}

A Stream that is played by the mobile unit can be synthesized.

Spatial Synthesis allows different segments of the video area to be synthesized by different streams.

As an example, the display space of a video advertisement on the screen is divided into two sub-spaces. The one subspace can be streaming personalized information. E.g. Stream: “Hello Stella. We have a 99c offer on our product . . . .”

Both Personalized Spatial Stream Synthesis (P-SSS) and Context Sensitive Spatial Stream Synthesis (CS-SSS) can be used.

Temporal Synthesis can interrupt the sequence of a video or other streams by personalized streams. In the above example a sequence of frames with the picture 99c can be inserted within the sequence of a video stream, creating an synthesis effect.

The Streaming Interface may also be Context Sensitive. As an example, when a customer approaches a product in a store, the Streaming Human Interface has 2 windows, displaying in the first one a Cola advertisement and in the second one a News video content.

As the customer moves towards a snacks-brand area, the Streaming Control Interface sends control information for 3 windows. The first window displays a video advertisement for a snack product, snack1 the second window displays a video advertisement for a snack product snack2 of the same brand and the third window displays free entertainment content such as a video from a football game.

The content delivery can also include real Time Context Sensitive Internet Access. As a user walks within a Context Sensitive environment, the context sensitive thin streams internet information, that is loaded into a browser and automatically provide content from the associated web-site of the respective context sensitive thin stream.

Other options can include zooming with navigational patterns. This allows the client to zoom to specific areas of the content and navigate like a map.

All the discount offers throughout the whole store can also be displayed, either as a static image file or through the web with the included web browser. The URL links point to the web sites of the store and the product suppliers.

A number of business scenarios are possible.

Scenario 1.
A TSG is attached close to an object, e.g. close to a Cola can anywhere in a store.
The TSG receives its context when an employee of the Cola brand associates the hardware code of the TSG with its context sensitive identification through the web.
If the TSG has attached on it an RFID reader and the Cola brand has an RFID tag on the cola can or on the shelf where the cola cans are located, the context sensitive identification is done autonomously by the TSG.
The TSG broadcasts its context within the network. The representatives of the Cola brand start using the TSG to broadcasting streaming information about the Cola product and its brand.
If the TSG is of the form of (display type) it can enhance the broadcasting information with video commercials.

Scenario 2.
A static TSG is broadcasting streaming information about the Cola product and its brand.
A mobile TSG of the form of placed on a cart receives the streaming information
The person chooses to disclose his existence in the proximity of the product.
He/she also chooses to release to the system personal information such as his shopping list or personal preferences (customer profile).
The personalized TSG is entering into a bidirectional communication with the localized TSG.
The person (shopper) receives personalized commercials content in video format and special, personal discount, as his profile matches a targeted segment for a special promotion by the Cola Brand.
The manufacturer suggests to the person a list of sponsored services.
The person chooses to watch a video clip and simultaneously browse the internet for 3 minutes.
The manufacturer of the Cola offers a special promotion on other products (e.g. a special Cola refrigerator).

Scenario 3.
The shopper wants to pay directly to the manufacturer of the product, e.g. with a credit card number. The user switches into the wired communication available at both TSGs by plugging in the necessary cable.
The manufacturer receives the credit card number and arranges for the delivery of the refrigerator to the customer.

Scenario 4.
A manufacturer wants to offer a customer video sports content from the Lakers game happening at that moment.
The manufacturer has attached close to his products a static TSG. Once a mobile TSG enters accepts a bidirectional communication the content starts being transmitted through the wireless backbone directly to the mobile TSG. Through the wired backbone the manufacturer delivers the sports video content in real-time.
The duration of the content ends and the person wants to watch some more content.
The user wires the TSG through the wired link directly on the backbone network of the Thin Stream Blanket Architecture, or any other backbone network. Payment may be made by credit card number.
The person continues to enjoy content. Each of the TSGs creates a virtual store within the physical space (i.e. the technology streams digital information about a product at the physical space. This product is displayed or reachable).

Scenario 5:

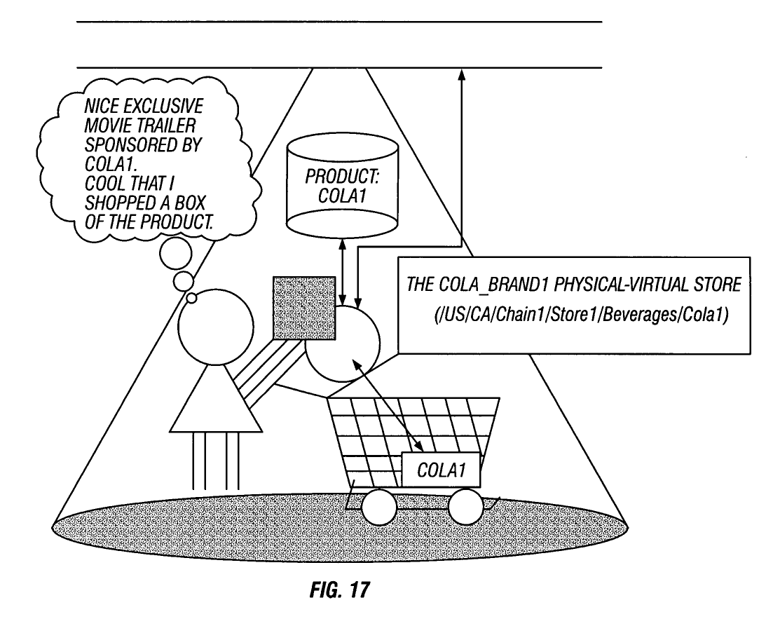

A person with a TSG device is entering the Physical-Virtual Store of Cola_Brand1 as shown in FIG. 17.

The Cola_Brand1 Virtual Store can be managed in real time through the Internet or a proprietary WAN. The customer can enter in direct multimedia communication (videoconferencing, chatting, phone calls) with representatives of the supplier/manufacturer, retailer, or dietary professionals.

The customer chooses to enter the Physical-Virtual Store and its area of bidirectional communication.

With the shopper's approval, the RFID reader on the customer's mobile TSG device transmitting with the information about what the user has already taken into the shopping cart, thus helping the supplier of the Physical-Virtual Store to suggest complimentary products or create bundles with his own product lines with the shopper's preferences.

Even without the RFID reader, the customer can communicate preferences to the supplier via chatting, messaging, videoconferencing or by sending to the supplier a shopping list.

Suppliers' Reservation System.

The store floor can be marked by the physical short-range coverage of the proximity communication link of Physical-Virtual Stores.

The floor can be reserved by online methods such as through the internet or WAN.

The above reservations can be done with the visual help of a map of the floor of the store. The above methods can be extended into the 3-D space, and can be extended in any multidimensional domain (including time), and can be extended for any physical location in the world.

Alternative Usage of a Mobile TSG.

A person with a TSG device with an RFID reader is approaches the space of a Product: Cola_Brand1. The RFID reader identifies the context, names the TSG device of the customer and creates a bidirectional communication channel with the supplier of Cola_Brand1, directly through the Wi-Fi network backbone.

A. Minimized configuration of the system when the wireless backbone coverage is limited in the retail store.

Static TSGs can simply stream beacons identifying their context. Mobile TSGs are streaming content to their user from the Streaming cache which is updated when within the limited wireless areas in the store or when linked to a wireless backbone at intervals.

Window Shopping Scenario.

TSGs are placed within the windows of shops. Shoppers with wireless devices such as PDAs, or cell-phones with their proximity communicators (such as Bluetooth or other) are connected to our system and are enjoying context sensitive streaming services.

This can enable shopping and trading even during the times that the shops are closed (e.g. evening, holidays).

The physical-virtual store concept offers a greater experience than the one offered by the internet as it is enhanced by the physical experience of the products as in this scenario they are displayed within the windows of the stores.

Although only a few embodiments have been disclosed in detail above, other embodiments are intended to be included. For example, while the above has described software modules, it should be understood that the functions described herein could be alternatively implemented in hardware, e.g., using FPGAs or the like. Also, while this describes each of the TSGs being formed of identical hardware, the hardware can actually be different for different units.

All such modifications are intended to be encompassed within the following claims. What is claimed is

1. A system, comprising:
a first computing part, having a first capability of receiving context-sensitive information, a second part which communicates using a limited distance communication, said first computing part inferring proximity based on receiving said limited distance information, and determines information about said context sensitive information based on said proximity.

2. A system as in claim 1, further comprising a network connection, separate from the limited distance communication, said network connection having a higher bandwidth capability than said limited distance communication, and having a longer communication range than said limited distance communication.

3. A system as in claim 2, wherein said context sensitive information includes receiving streaming information.

4. A system as in claim 3, further comprising a cache that stores parts of said streaming information which can be selected by said context sensitive information.

5. A system as in claim 1, wherein said second part includes a short range radio establishing a first communication, and a reader part, which reads identifying information from a remotely readable device as a second communication.

6. A system as in claim 5, wherein said reader part is an RFID reader which reads identifying information from RFID tags.

7. A system as in claim 2, wherein said computing part determines its position by inferring that it is close to a source of said limited distance communication, and selects streaming information to be sent over said network connection based on said determined position.

8. A system as in claim 1, wherein said context sensitive information includes streaming information.

9. A system as in claim 8, wherein said computing part determines its position by inferring that it is close to a source of said limited distance communication, and by, reading identification information from said reader part.

10. A system as in claim 9, further comprising a display unit operating to display said streaming information.

11. A system as in claim 10, wherein said system is optimized for use in a store, and said short distance communication communicates information about products within the store, and said streaming information is based on said products within the store.

12. A system as in claim 2, further comprising an additional computing part, communicating with said first computing part over said short distance communication, and capable of sending information to said first computing part and receiving information from said first computing part.

13. A system as in claim 12, wherein said information from said network connection can be sent from said first computing part to said additional computing part, and further comprising a third computing part, and said information from said network connection can be sent from said additional computing part to said third computing part.

14. A system as in claim 12, wherein said first computing part and said additional computing part each include a handoff capability, controlling handoff of communication over said short distance communication part between said first computing part and said second computing part without interrupting said stream.

15. A system as in claim 10, wherein said display unit operates to display multiple items of streaming information, and wherein said first computing part operates to automatically determine priority of said streaming information, and sets a position on said display based on said priority.

16. A system as in claim 15, further comprising a personalization part, which allows personalization to be used as a parameter for determining the priority of streaming information.

17. A system as in claim 11 wherein said first computing part operates in a listen only mode, to maintain privacy.

18. A system as in claim 15, further comprising a control which allows reorganizing buttons on the display.

19. A system as in claim 15, wherein said computing part operates to adaptively determine pricing information and wherein said streaming information includes said adaptively determined pricing information.

20. A system as in claim 15, wherein said first computing part operates to negotiate prices between different products of similar type.

21. A system as in claim 15, wherein said first computing part receives streaming information including coupon information for special pricing.

22. A system as in claim 5, wherein said determining context comprises reading a plurality of items of information second part and said reader part, and interpolating said proximity based on said plurality of items of information.

23. A system as in claim 22, wherein said interpolating includes selecting an identifier which is used most often, and establishing said proximity based on said identifier.

24. A system as in claim 2, further comprising second and third computing parts, each having said limited distance communication capability, and each communicating with said first computing part bidirectionally, and wherein said first computing part can communicate information from said network connection to either or both of said second and/or third communicating parts, and receive information from either or both of said second and third communicating parts and provide said information to said network.

25. A system as in claim 1, wherein said second part includes a limited distance radio.

26. A system as in claim 1, wherein said second part includes an RFID reader.

27. A method, comprising:
establishing a plurality of transmissions, each transmissions representing a specific area, and each transmission having an established probable range; and
receiving each of said transmissions, and deducing a current area from the collection of transmissions; and
determining context sensitive streaming information associated with the deduced area.

28. A method as in claim 27, wherein each area represents a product in a store, and at least part of the context sensitive streaming information represents one of said products in said store.

29. A method as in claim 24, wherein said deducing comprises maintaining a list of said transmissions, and counting areas within said transmissions, and establishing one of the areas as a deduced area based on that one area having the most number of transmissions.

30. A method as in claim 27, wherein said plurality of transmissions include a limited distance transmission, a network connection, separate from the limited distance transmission, said network transmission having a higher bandwidth capability than said limited distance transmission, and having a longer communication range than said limited distance communication.

31. A method as in claim 30, wherein said transmissions further include a reader transmission carrying identifying information from a remotely readable device as a second communication.

32. A method as in claim 31, wherein said reader transmission is an RFID reader which reads identifying information from RFID tags.

33. A method as in claim 27, further comprising determining a position of a source of said limited distance communication, and deducing that position as a current position, and said determining streaming information comprises using said current position.

34. A method as in claim 27, further comprising displaying said streaming information.

35. A method as claim 27, wherein said transmissions are between a first fixed part, and a second fixed part, and a third movable part, at least one of said parts having a network connection, and wherein information from said network connection can be sent from said one of said parts, to the other parts.

36. A system as in claim 35, further comprising controlling handoff of communication between different units, without interrupting said communication.

37. A system, comprising:
a first gateway, having a connection to a higher-capacity network, and also having a lower capacity network which operates over the limited and control range, said first gateway producing communications over said lower capacity network, which communications are indicative of a location of said first gateway;
a second gateway, having communicator which communicates with said lower capacity network, when in range of said lower capacity network, and which operates to receive transmissions from said lower capacity network when in range, at least one of said lower capacity network transmissions including streaming content, which is sent from said first gateway to all communication elements which are within range, and wherein said streaming content is representative of a product in a store which is in an area of said first gateway.

38. A system as in claim 37, wherein said first gateway also includes an information reader, which reads information from its local area, and automatically determines from reading said information from said local area, streaming content to be sent.

39. A system as in claim 26, further comprising a network connection, separate from the limited distance communication, said network connection having a higher bandwidth capability than said limited distance communication, and having a longer communication range than said limited distance communication.
